(19) United States
(12) Patent Application Publication
(10) Pub. No.: US 2026/0291655 A1
(43) Pub. Date: Sep. 24, 2026

(54) COMMUNICATIONS USING AN UPLINK-ONLY STATE

(71) Applicant: QUALCOMM Incorporated, San Diego, CA (US)

(72) Inventors: Zhichao ZHOU, Beijing (CN); Diana MAAMARI, San Diego, CA (US); Ahmed ELSHAFIE, San Diego, CA (US); Mickaël MONDET, Louannec (FR)

(21) Appl. No.: 19/480,259

(22) PCT Filed: Jul. 4, 2023
(86) PCT No.: PCT/CN2023/105649

§ 371 Date: Oct. 30, 2025

(51) Int. Cl. H04L 1/1829; H04W 52/02; H04W 72/232

(52) U.S. Cl. CPC H04L 1/1848; H04W 52/0235; H04W 72/232

(57) ABSTRACT

Various aspects of the present disclosure generally relate to wireless communication. In some aspects, a user equipment (UE) may receive a first indication of an allocation of resources associated with a communication. The UE may transmit a negative acknowledgment (NACK) associated with the communication. The UE may receive, based at least in part on transmitting the NACK, a second indication to postpone initiation of an uplink-only state. Numerous other aspects are described.

### FIELD OF THE DISCLOSURE

Aspects of the present disclosure generally relate to wireless communication and to techniques and apparatuses for communications using an uplink-only state.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a user equipment (UE). The method may include receiving a first indication of an allocation of resources associated with a communication. The method may include transmitting a negative acknowledgment (NACK) associated with the communication. The method may include receiving, based at least in part on transmitting the NACK, a second indication to postpone initiation of an uplink-only state.

Some aspects described herein relate to a method of wireless communication performed by a UE. The method may include receiving an indication of an allocation of resources associated with a communication. The method may include transmitting a NACK associated with the communication. The method may include initiating an uplink-only state based at least in part on transmitting the NACK. The method may include initiating, after initiating the uplink-only state, an uplink and downlink state.

Some aspects described herein relate to a UE for wireless communication. The UE may include one or more memories and one or more processors coupled to the one or more memories. The one or more processors may be configured to receive a first indication of an allocation of resources associated with a communication. The one or more processors may be configured to transmit a NACK associated with the communication. The one or more processors may be configured to receive, based at least in part on transmitting the NACK, a second indication to postpone initiation of an uplink-only state.

Some aspects described herein relate to a UE for wireless communication. The UE may include one or more memories and one or more processors coupled to the one or more memories. The one or more processors may be configured to receive an indication of an allocation of resources associated with a communication. The one or more processors may be configured to transmit a NACK associated with the communication. The one or more processors may be configured to initiate an uplink-only state based at least in part on transmitting the NACK. The one or more processors may be configured to initiate, after initiating the uplink-only state, an uplink and downlink state.

Some aspects described herein relate to a non-transitory computer-readable medium that stores a set of instructions for wireless communication by a UE. The set of instructions, when executed by one or more processors of the UE, may cause the UE to receive a first indication of an allocation of resources associated with a communication. The set of instructions, when executed by one or more processors of the UE, may cause the UE to transmit a NACK associated with the communication. The set of instructions, when executed by one or more processors of the UE, may cause the UE to receive, based at least in part on transmitting the NACK, a second indication to postpone initiation of an uplink-only state.

Some aspects described herein relate to a non-transitory computer-readable medium that stores a set of instructions for wireless communication by a UE. The set of instructions, when executed by one or more processors of the UE, may cause the UE to receive an indication of an allocation of resources associated with a communication. The set of instructions, when executed by one or more processors of the UE, may cause the UE to transmit a NACK associated with the communication. The set of instructions, when executed by one or more processors of the UE, may cause the UE to initiate an uplink-only state based at least in part on transmitting the NACK. The set of instructions, when executed by one or more processors of the UE, may cause the UE to initiate, after initiating the uplink-only state, an uplink and downlink state.

Some aspects described herein relate to an apparatus for wireless communication. The apparatus may include means for receiving a first indication of an allocation of resources associated with a communication. The apparatus may include means for transmitting a NACK associated with the communication. The apparatus may include means for receiving, based at least in part on transmitting the NACK, a second indication to postpone initiation of an uplink-only state.

Some aspects described herein relate to an apparatus for wireless communication. The apparatus may include means for receiving an indication of an allocation of resources associated with a communication. The apparatus may include means for transmitting a NACK associated with the communication. The apparatus may include means for initiating an uplink-only state based at least in part on transmitting the NACK. The apparatus may include means for initiating, after initiating the uplink-only state, an uplink and downlink state.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIG. 4 is a diagram illustrating an example of a communication link that supports a low-power state and a high-power state, in accordance with the present disclosure.

FIG. 5 is a diagram illustrating an example of a retransmission using a communication link that supports an uplink-only state (e.g., low-power state) and an uplink and downlink state (e.g., a high-power state), in accordance with the present disclosure.

FIG. 6 is a diagram of an example associated with communications using an uplink-only state, in accordance with the present disclosure.

FIG. 7 is a diagram illustrating an example of a wake-up receiver (WUR) that supports reception of a wake-up signal (WUS) when a main receiver is in an uplink-only state, in accordance with the present disclosure.

FIG. 8 is a diagram illustrating examples of a WUS to indicate to a UE to initiate an uplink and downlink state, in accordance with the present disclosure.

FIG. 9 is a diagram illustrating an example process performed, for example, by a UE, in accordance with the present disclosure.

FIG. 10 is a diagram illustrating an example process performed, for example, by a UE, in accordance with the present disclosure.

FIG. 11 is a diagram of an example apparatus for wireless communication, in accordance with the present disclosure.

### DETAILED DESCRIPTION

In some networks, a user equipment (UE) may be configured to communicate using an uplink-only state and using an uplink and downlink state. For example, the UE may be configured to switch between the uplink-only state and the uplink and downlink state (e.g., based at least in part on a periodicity). Based at least in part on using the uplink-only state between periods of using the uplink and downlink state, the UE may conserve power based at least in part on, for example, allowing for a PDCCH and PDSCH reception circuit to be turned off. In some examples, the UE may request a retransmission of a downlink communication that failed during the uplink and downlink state. However, the UE may initiate the uplink-only state before receiving the retransmission of the downlink communication and/or before receiving a scheduling message associated with the retransmission of the downlink communication. In this way, the UE may fail to receive the retransmission scheduling message and the UE may not receive the PDSCH message and/or a retransmission of the PDSCH message. The UE may consume power, computing, and/or communication resources to attempt to recover from failing to receive the PDSCH communication and/or a user experience may degrade.

Various aspects relate generally to communications using an uplink-only state. Some aspects more specifically relate to configurating switching between an uplink-only state and an uplink and downlink state in a way that supports retransmissions that may otherwise occur or be scheduled during the uplink-only state. In some examples, a UE may receive a downlink control information (DCI) message that triggers postponing a switch to the uplink-only state (or another low-power state). In some aspects, the UE may receive a wake-up signal (WUS)-based trigger that postpones switching between the uplink-only state and the uplink and downlink state. Based at least in part on receiving the DCI message or the WUS-based trigger, the UE may remain in the uplink and downlink state to support reception of a retransmission and/or a scheduling message associated with the retransmission.

In some aspects, the UE may be configured to switch to the uplink-only state after transmitting a negative acknowledgment (NACK) and to switch back to the uplink and downlink state based at least in part on receiving an indication from a network node. In this way, the UE may switch to the uplink and downlink state only once, triggered by the network node, which may allow the UE to remain in the uplink-only state for as long as possible.

In some aspects, the UE may be configured to switch to the uplink-only state after transmitting a NACK, and to switch back to the uplink and downlink state based at least in part on an autonomous decision at the UE (e.g., based at least in part on an expected time for receiving a retransmission associated with the NACK). In this way, the UE may conserve network resources that may have otherwise been used to communicate the indication to switch back to the uplink and downlink state.

In some aspects, the UE may switch to the uplink-only state to transmit time-sensitive uplink packets before reception of the retransmission.

In some aspects, the UE may receive a configuration of timers and/or parameters associated with state switching intervals. In some aspects, the timers and/or parameters may be associated with different quality of service (QoS) requirements.

In some aspects, the UE may transmit an uplink communication associated with a resource for a hybrid automatic repeat request (HARQ) acknowledgment (HARQ-ACK) from the network node that would occur during an uplink-only state of the UE. The UE may remain in the uplink-only state, or may initiate the uplink-only state, after transmitting the uplink communication and may switch to the uplink and downlink state based at least in part on receiving an indication to switch from the network node or based at least in part on an expected time for receiving the HARQ-ACK.

In some aspects, the UE may include a wakeup receiver (WUR) and a main receiver. The WUR may consume a reduced amount of power relative to the main receiver. The UE may use the WUR to receive a WUS when in an uplink-only state. Based at least in part on receiving the WUS via the WUR, the UE may initiate an uplink and downlink state for the main receiver.

Particular aspects of the subject matter described in this disclosure can be implemented to realize one or more of the following potential advantages. In some examples, by configuring the UE to receive a retransmission, to receive a scheduling message for the retransmission, and/or to receive a NACK from the network node during a resource that may otherwise be associated with an uplink-only state, the described techniques can be used to increase a likelihood of receiving or transmitting a retransmission of a communication that failed. In this way, the UE and the network node may conserve power, computing, communication, and/or network resources that may have otherwise been used to detect and correct the failed communication and or to communicate using one or more communication parameters configured to reduce a likelihood of a failed communication (e.g., based at least in part on reducing spectral efficiency to reduce an error rate). Additionally, or alternatively, the UE and the network node may improve a user experience.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

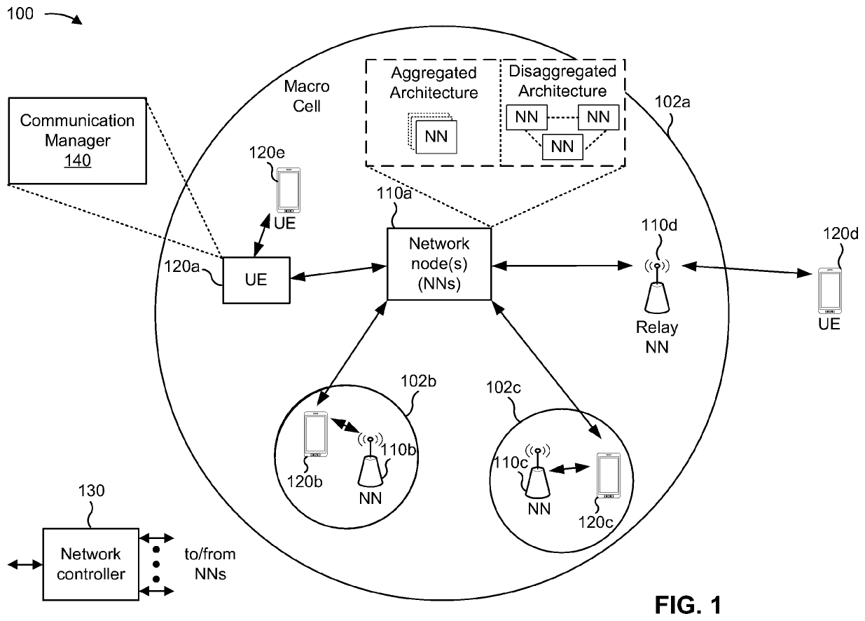

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, an unmanned aerial vehicle, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IOT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive a first indication of an allocation of resources associated with a communication; transmit a NACK associated with the communication; and receive, based at least in part on transmitting the NACK, a second indication to postpone initiation of an uplink-only state.

In some aspects, the communication manager 140 may receive an indication of an allocation of resources associated with a communication; transmit a NACK associated with the communication; initiate an uplink-only state based at least in part on transmitting the NACK; and initiate, after initiating the uplink-only state, an uplink and downlink state. Additionally, or alternatively, the communication manager 140 may perform one or more other operations described herein.

As indicated above, FIG. 1 is provided as an example. Other examples may differ from what is described with regard to FIG. 1.

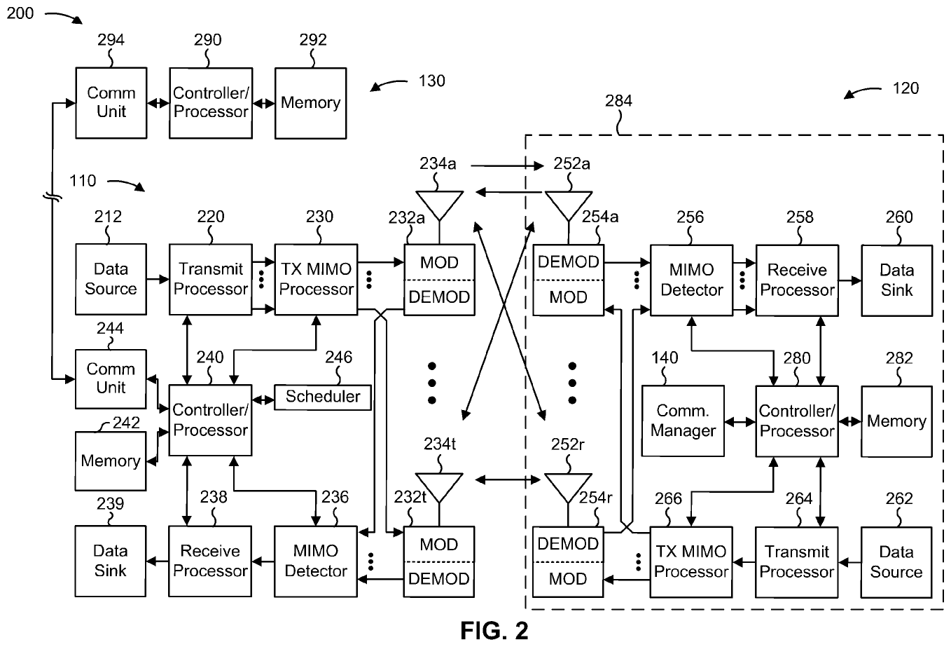

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

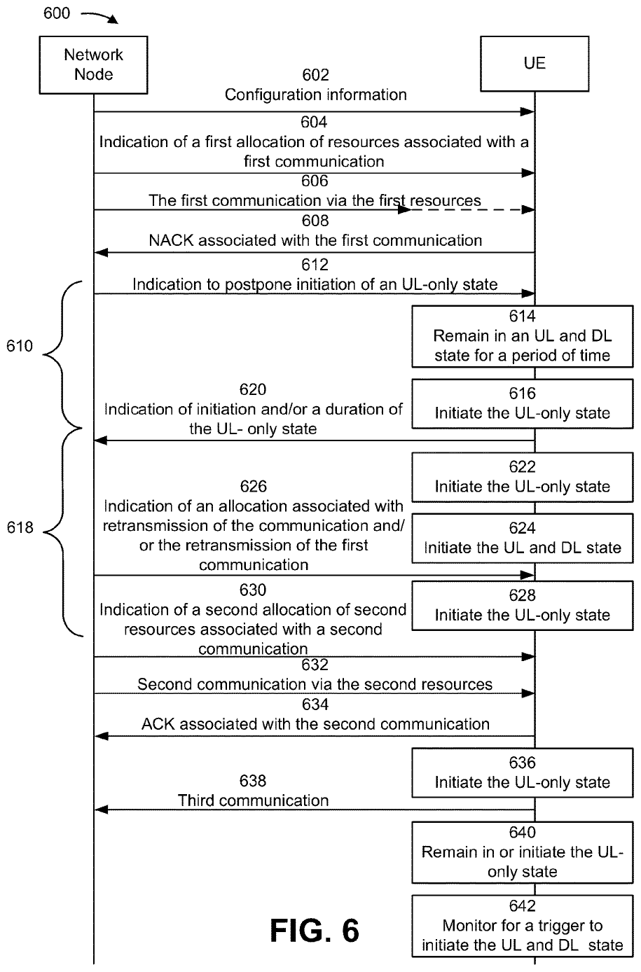

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 6-11).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 6-11).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

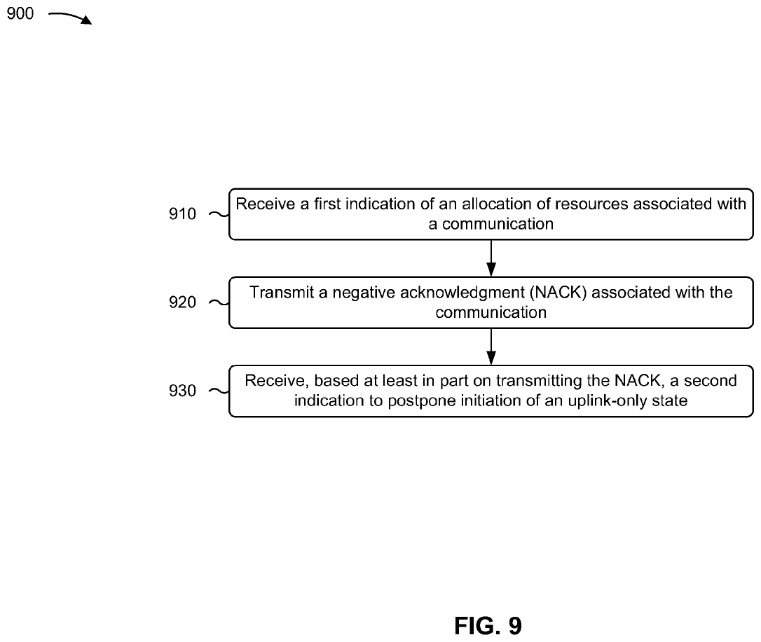

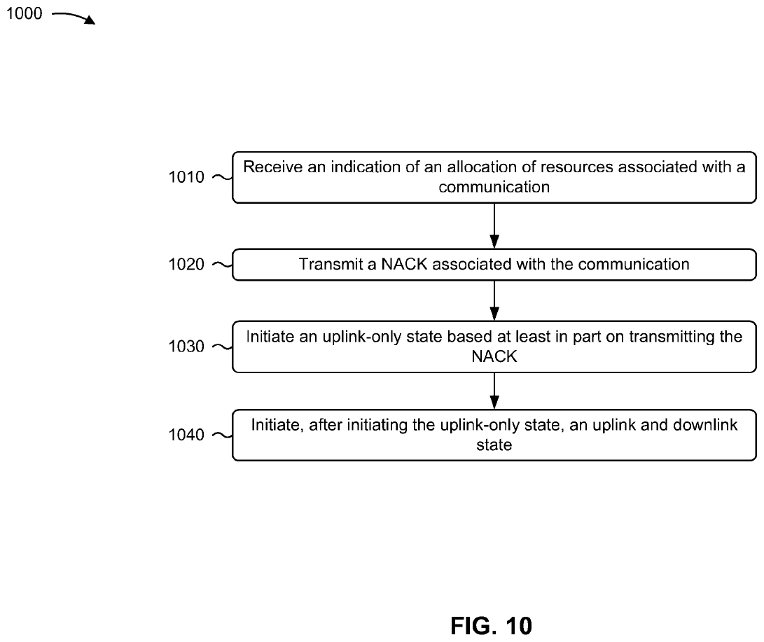

The controller/processor 240 of the network node 110, the controller/processor 280 of the UE 120, or any other component(s) of FIG. 2 may perform one or more techniques associated with communications using uplink-only states, as described in more detail elsewhere herein. For example, the controller/processor 240 of the network node 110, the controller/processor 280 of the UE 120, or any other component(s) (or combinations of components) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for receiving a first indication of an allocation of resources associated with a communication; means for transmitting a NACK associated with the communication; and/or means for receiving, based at least in part on transmitting the NACK, a second indication to postpone initiation of an uplink-only state. In some aspects, the UE 120 includes means for receiving an indication of an allocation of resources associated with a communication; means for transmitting a NACK associated with the communication; means for initiating an uplink-only state based at least in part on transmitting the NACK; and/or means for initiating, after initiating the uplink-only state, an uplink and downlink state. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

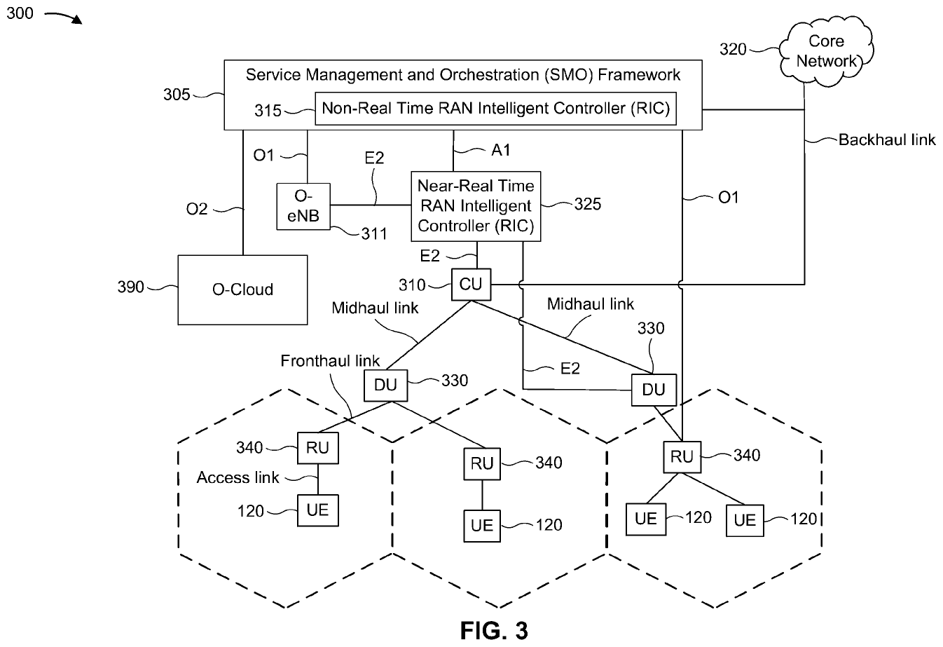

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

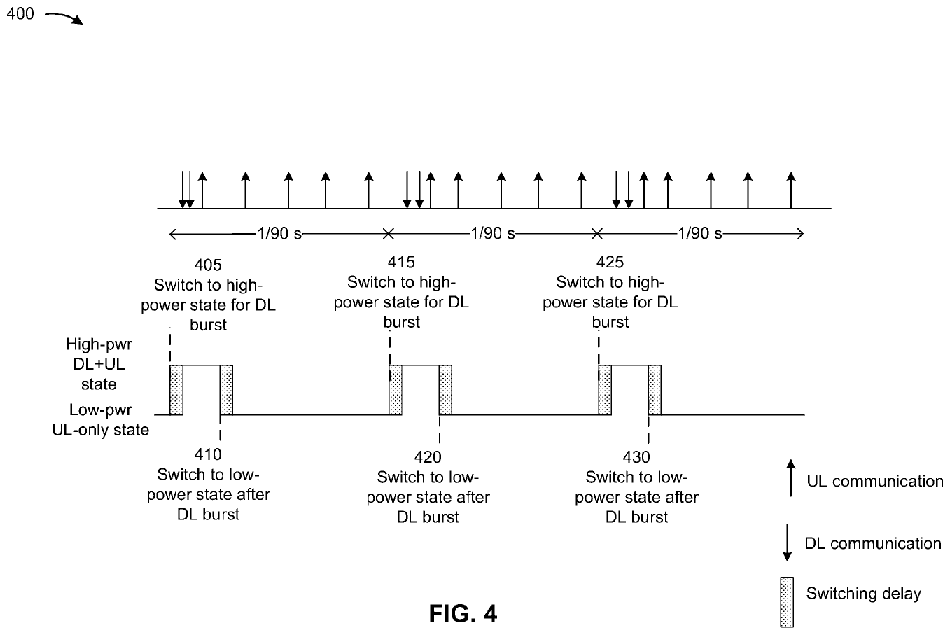

FIG. 4 is a diagram illustrating an example 400 of a communication link that supports a low-power state and a high-power state, in accordance with the present disclosure. A UE may consume less power when in the low-power state, relative to when in the high-power state, based at least in part on communicating with only uplink communications (an uplink-only state). The high-power state may be associated with support for communicating in an uplink direction and in a downlink direction (an uplink and downlink state).

As shown in FIG. 4, the UE may switch between the high-power state and the low-power state according to a periodic pattern (e.g., a duty cycle). In the example 400, the UE may begin in the low power (uplink-only state). As shown by reference number 405, the UE may switch to the high-power state for a downlink (DL) burst. While in the high-power state, the UE may receive the downlink burst and/or may continue to transmit uplink communications. As further shown in FIG. 4, a switching delay may occur when the UE is switching between the high-power state and the low-power state.

As shown by reference number 410, the UE may switch to the low-power state after the downlink burst. While in the low-power state, the UE may conserve power and computing resources based at least in part on refraining from monitoring a control channel and/or performing blind detection operations on signals detected within the control channel.

As shown by reference numbers 415-430, the UE may switch between the high-power state and the low-power state according to a periodicity. In the example shown in FIG. 4, the periodicity may be 1/90 second.

In some examples of communication links that support a low-power state and a high-power state, the UE may communicate during the low-power state based at least in part on a configured grant, with no downlink and/or downlink control channel monitoring (e.g., physical downlink control channel (PDCCH) monitoring). Additionally, or alternatively, a bandwidth part (BWP) bandwidth on a primary cell (PCell) may be matched to uplink traffic. The UE may have dormant BWPs on secondary cells (SCells) and/or the UE may communicate with a network node without PDCCH or physical downlink shared channel (PDSCH) communications while in the low-power state. In some examples of the low-power state, the UE may continue to support synchronization signal block (SSB) and/or tracking reference signal (TRS) reception to maintain physical layer (PHY) control loops at the UE.

Based at least in part on using the low-power state between periods of using the high-power state, the UE may conserve power based at least in part on, for example, allowing for a PDCCH and PDSCH reception circuit to be turned off.

As indicated above, FIG. 4 is provided as an example. Other examples may differ from what is described with regard to FIG. 4.

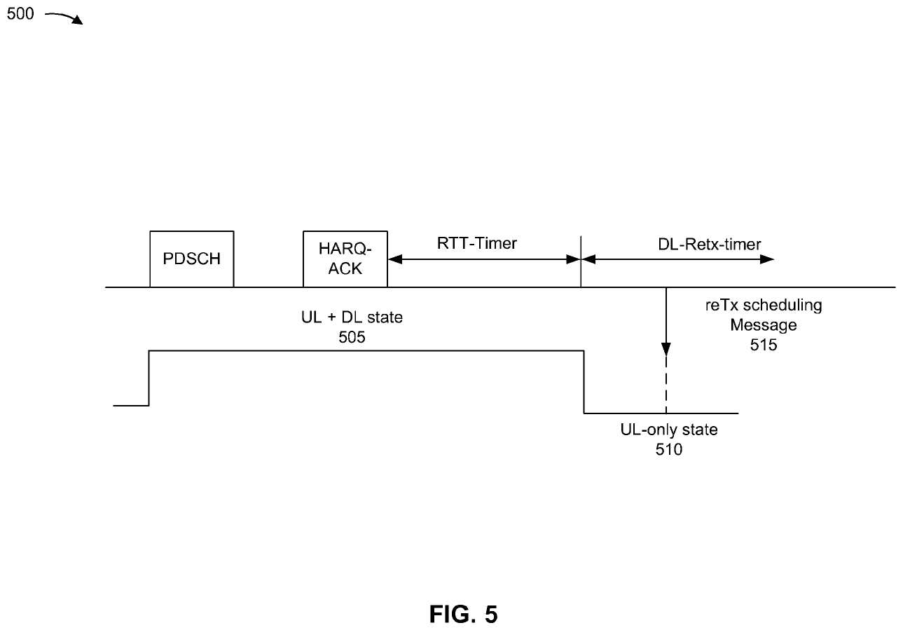

FIG. 5 is a diagram illustrating an example 500 of a retransmission using a communication link that supports an uplink-only state (e.g., low-power state) and an uplink and downlink state (e.g., a high-power state), in accordance with the present disclosure. As shown in FIG. 5, a UE may attempt to receive a PDSCH communication while in the uplink and downlink state (UL+DL state). The UE may transmit a hybrid automatic repeat request (HARQ) acknowledgement (ACK) associated with the PDSCH while in the uplink and downlink state. Based at least in part on transmitting a negative ACK (NACK) as the HARQ-ACK, the UE may initiate a round-trip time (RTT) timer. At expiration of the RTT timer, the UE may initiate a timer associated with a downlink retransmission time associated with retransmission of the PDSCH communication.

As shown in FIG. 5, the UE may initiate the uplink-only state 510 based at least in part on a configuration of the uplink-only state and the uplink and downlink state. For example, the UE may initiate the uplink-only state 510 based at least in part on inactivity of downlink communications and/or expiration of a time window associated with the uplink and downlink state.

As shown in FIG. 5, the network node may transmit a retransmission (reTx) scheduling message 515 after the UE initiates the timer associated with the downlink retransmission time, but after the UE initiates the uplink-only state 510. This may be based at least in part on the timer associated with the downlink retransmission time overlapping with the uplink-only state 510. In this way, the UE may fail to receive the retransmission scheduling message 515 and the UE may not receive the PDSCH message and/or a retransmission of the PDSCH message. The UE may consume power, computing, and/or communication resources to attempt to recover from failing to receive the PDSCH communication and/or a user experience may degrade.

As indicated above, FIG. 5 is provided as an example. Other examples may differ from what is described with regard to FIG. 5.

In some aspects described herein, if a UE fails to receive a PDSCH communication at an initial transmission, the UE may transmit a NACK to an associated network node. The UE may initiate a DL-RTT-timer and may also initiate a drx-RetransmissionTimerDL timer. The UE may initiate a low-power uplink-only state according to pre-configuration, which may cause the UE to be in the uplink-only state during a time period associated with the drx-RetransmissionTimerDL timer, unless a change is made. Based at least in part on receiving the NACK from the UE, to prevent the UE from initiating the uplink-only state, the network node may transmit a no-scheduling DCI message to indicate to the UE to postpone initiating the uplink-only state.

In some aspects, the DCI message may carry less information than a scheduling DCI, which may conserve overhead of an associated PDCCH. Based at least in part on the UE receiving the DCI, the UE may postpone initiating the uplink-only state. Once a timer of drx-RetransmissionTimerDL expires, the UE may initiate the uplink-only state (e.g., even if the UE has not yet received the retransmission).

In some aspects, the DCI message may indicate a specific timer, which may be shorter than the drx-RetransmissionTimerDL. Based at least in part on the network node knowing when to transmit a scheduling PDCCH, the network node may indicate a specific time length to the UE and notify the UE when the UE can switch to the uplink-only state. After the indicated timer expires, UE may switch to the uplink-only state.

In some aspects, the UE may autonomously determine to switch to the uplink-only state. For example, the UE may receive the DCI message and remain in the uplink and downlink state for an upcoming retransmission scheduling PDCCH and a scheduled PDSCH. After the UE receives the retransmission, the UE may autonomously switch to the uplink-only state (e.g., even if the drx-RetransmissionTimerDL is not yet expired).

Similar to the example of the DCI message, the UE may receive an indication to postpone initiating the uplink-only state via a WUS. In some aspects, the network node may transmit a low power WUS to indicate that the UE is not to initiate the uplink-only state based at least in part on an expected retransmission. In some aspects, the WUS may carry interval information to indicate to the UE when to switch to the uplink-only state. In some aspects, the UE may autonomously determine to switch to the uplink-only state. For example, the UE may receive the DCI message and remain in the uplink and downlink state for an upcoming retransmission scheduling PDCCH and a scheduled PDSCH. After the UE receives the retransmission, the UE may autonomously switch to the uplink-only state (e.g., even if the drx-RetransmissionTimerDL is not yet expired).

In some aspects (e.g., in an alternative to remaining in the uplink and downlink state), the UE may default to switch to the uplink-only state first and then switch back to the uplink and downlink state based at least in part on reception of an indication from the network node (e.g., for retransmission of a communication). If the UE fails to receive a PDSCH communication at an initial transmission, the UE transmits a NACK to the network node. Based at least in part on transmitting the NACK, the UE may not initiate a DL-RTT-timer or a drx-RetransmissionTimerDL. Instead, the UE may switch to the uplink-only state for power saving. Based at least in part on the network node receiving the NACK from the UE, the network node may transmit an indication to the UE to switch back to the uplink and downlink state.

In some aspects, the network node may use a WUS (e.g., a low-power WUS) or a DCI message (e.g., a no-scheduling DCI message) to indicate to the UE to switch back to the uplink and downlink state for an upcoming retransmission PDCCH monitoring and an associated PDSCH. Once the UE receives the retransmission, the UE may switch back to the uplink-only state.

In some aspects, the UE may autonomously determine whether to switch to the uplink-only state based at least in part on an initial reception of a downlink communication. For example, if the UE receives an initial transmission of the downlink communication (e.g., a PDSCH communication), it may be unnecessary for the UE to initiate an RTT-timer stage and a reTx-timer stage. Instead, the UE may, after transmitting an acknowledgment (ACK) to the network node, enter the uplink-only state autonomously (e.g., without receiving an indication from the network node). If the UE fails to receive the downlink communication, the UE may transmit a NACK to the network node. The UE may autonomously initiate the RTT-timer stage and the drx-reTx-timer-DL stage to prepare for an upcoming retransmission.

In some aspects, the UE may use an enhanced connected mode discontinuous reception (eCDRX) configuration, not enter the uplink-only state, and switch to the uplink-only state after expiration of the drx-RetransmissionTimerDL. In some aspects, the UE may switch between the uplink and downlink state and the uplink-only state as described in other examples.

In some aspects, the UE may initiate the uplink-only state for time-sensitive (e.g., time-stringent) uplink packets transmission before preparing to receive an upcoming retransmission. For example, after transmitting a NACK, if the UE has latency-sensitive uplink packets buffered for transmission, the UE may initiate, or remain in, the uplink-only state first and then switch to the uplink and downlink state.

For example, the UE may remain in the uplink-only state first and then switch to the uplink and downlink state based at least in part on a trigger (e.g., DCI or WUS) or an autonomous decision. In some aspects, the UE may transmit the time-sensitive uplink packets while in the uplink-only state and switch back to the uplink and downlink state before a start of drx-RetransmissionTimerDL. In this case, the transmission of the time-sensitive uplink packets may not interfere with the expected retransmission and/or associated scheduling.

In some aspects, the UE may indicate, using uplink control information (UCI) to the network node, that the UE intends to initiate the uplink-only state UL-only state for latency-sensitive uplink packets. Additionally, or alternatively, the UE may further indicate a duration (e.g., length of time) of the uplink-only state (e.g., piggybacked on a PUSCH communication). Based at least in part on the network node receiving the UCI and/or the PUSCH, the network node may identify a timing for the uplink-only state and the network node may transmit a scheduling PDCCH to schedule the retransmission and the retransmission (e.g., via PDSCH) after the duration of the uplink-only state. After expiration of the duration of the uplink-only state, the UE may switch to the uplink and downlink state for the expected retransmission.

In some aspects, the UE may receive a radio resource control (RRC) message that configures timers for variable state intervals (e.g., the uplink and downlink state and/or the uplink-only state, among other examples). In some aspects, the timers may be configured with different parameters for different QoS requirements. For example, a timer associated with a duration of the uplink and downlink state may have different values associated with traffic having different QoS requirements. Similarly, a timer associated with a duration of the uplink-only state may have different values associated with traffic having different QoS requirements.

In some aspects, the UE may comply with timers from the configuration based at least in part on one or more parameters of current traffic. In some aspects, the network node may indicate to change the configuration using a DCI communication and/or a WUS, as discussed for other examples. In some aspects, once configured with parameters for the uplink and downlink state and the uplink-only state, the configuration may be activated or deactivated via a MAC control element (CE) or DCI (e.g., to select parameters from a set of candidate parameters indicated via RRC). In some aspects, pre-configured interval parameters for different states may be modified by MAC CE or DCI.

In some aspects, the UE may transmit a communication for which a HARQ-ACK may occur within an uplink-only state, unless adjusted. In some aspects, the UE may remain in the uplink-only state rather than initiate the UL-RTT-timer stage, and then initiate a drx-RetransmissionTimerUL stage to save power resources. If the network node does not receive the communication (e.g., a physical uplink shared channel (PUSCH) communication), the network node may send an indication to switch to the uplink and downlink state to monitor a PDCCH associated with retransmission scheduling and to receive the associated retransmission. In some aspects, the network node may transmit the indication using a DCI or a WUS, among other examples.

In some aspects, the UE may receive the WUS described herein based at least in part on using a wakeup receiver (WUR). For example, the WUR may consume less power than a main receiver and may be used to receive a WUS when the main receiver is in the uplink-only state. Based at least in part on receiving a WUS via the WUR, the UE may initiate an uplink and downlink state for the main receiver.

In some aspects, the UE may transmit a PUSCH communication in the uplink direction or may transmit HARQ feedback and then initiate the uplink-only state, while keeping the WUR active. Based at least in part on failing to receive the PUSCH communication or the HARQ feedback indicating a NACK, the network node may transmit a retransmission scheduling message. Before the network node transmits the retransmission scheduling message, the network node may first transmit a WUS trigger to indicate to the UE to switch states. The UE may trigger the main receiver to switch to the uplink and downlink state for the upcoming retransmission scheduling PDCCH and corresponding PDSCH or PUSCH. In some aspects, an interval between reception of the WUS and the main receiver switching to the uplink and downlink state may be configured by RRC or MAC CE signaling.

Based at least in part on configuring the UE to receive a retransmission, to receive a scheduling message for the retransmission, and/or to receive a NACK from the network node during a resource that may otherwise be associated with an uplink-only state, the described techniques can be used to increase a likelihood of receiving or transmitting a retransmission of a communication that failed. In this way, the UE and the network node may conserve power, computing, communication, and/or network resources that may have otherwise been used to detect and correct the failed communication and or to communicate using one or more communication parameters configured to reduce a likelihood of a failed communication (e.g., based at least in part on reducing spectral efficiency to reduce an error rate). Additionally, or alternatively, the UE and the network node may improve a user experience.

FIG. 6 is a diagram of an example 600 associated with communications using an uplink-only state, in accordance with the present disclosure. As shown in FIG. 6, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 6.

As shown by reference number 602, the network node may transmit, and the UE may receive, configuration information. In some aspects, the UE may receive the configuration information via one or more of RRC signaling, one or more MAC CEs, and/or DCI, among other examples. In some aspects, the configuration information may include an indication of one or more configuration parameters (e.g., already known to the UE and/or previously indicated by the network node or another network device) for selection by the UE, and/or explicit configuration information for the UE to use to configure the UE, among other examples.

In some aspects, the configuration information may indicate that the UE is to receive a retransmission, to receive a scheduling message for the retransmission, and/or to receive a NACK from the network node during a resource that may otherwise be associated with an uplink-only state. In some aspects, the configuration information may indicate parameters for switching between communication states in associated with retransmissions. For example, the parameters may include a first duration of a timer associated with reception of an allocation of resources associated with a retransmission of the communication, a second duration of the uplink-only state, and/or a third duration of the uplink and downlink state, among others. In some aspects, the parameters may be associated with traffic types (e.g., QoS parameters) of a communication associated with a retransmission. In some aspects, the network node may transmit an indication of a selection of one or more of the first duration, the second duration, or the third duration from a previously indicated set of candidate first durations, candidate second durations, or candidate third durations. For example, the network node may transmit the indication of the selection via dynamic signaling (e.g., DCI or MAC CE) or semi-static signaling (e.g., RRC).

The UE may configure itself based at least in part on the configuration information. In some aspects, the UE may be configured to perform one or more operations described herein based at least in part on the configuration information.

As shown by reference number 604, the UE may receive, and the network node may transmit, an indication of a first allocation of resources associated with a first communication. For example, the indication may be a semi-persistent-scheduling (SPS)-based indication of the first allocation or a DCI-based indication of the first allocation, among other examples.

As shown by reference number 606, the network node may transmit, and the UE may fail to receive, the first communication via the first resources.

As shown by reference number 608, the UE may transmit, and the network node may receive, a NACK associated with the first communication.

As shown by reference number 610, the UE may perform one or more operations, described in connection with reference numbers 612-616, to support a retransmission of the first communication.

As shown by reference number 612, the UE may receive, and the network node may transmit, an indication to postpone initiation of an uplink-only state. In some aspects, the network node may transmit the indication to postpone initiation of the uplink-only state based at least in part on an expectation of the network node to transmit a retransmission of the first communication.

In some aspects, the indication to postpone initiation of the uplink-only state comprises a DCI message (e.g., a no-scheduling DCI message) or a WUS, among other examples. In some aspects, the indication may include an indication of a time window (e.g., a start time, a duration, and/or an end time) during which the UE is to postpose initiation of the uplink-only state.

As shown by reference number 614, the UE may remain in an uplink and downlink state for a period of time. For example, the UE may remain in the uplink and downlink state based at least in part on receiving the indication to postpone initiation of the uplink-only state. In some aspects, the period of time may be based at least in part on a configured time duration. In some aspects, the period of time may expire based at least in part on reception of one or more downlink communications (e.g., a scheduling message and/or a retransmission of the first communication).

As shown by reference number 616, the UE may initiate the uplink-only state (e.g., after the period of time). In some aspects, the UE may conserve power resources while in the uplink-only state, as compared to the uplink and downlink state.

In some aspects, the UE may initiate the uplink-only state based at least in part on receiving a retransmission of the first communication. For example, the UE may postpone initiation of the uplink-only state for the purpose of receiving the retransmission and may initiate the uplink-only state to conserve power resources once the retransmission is received. In some aspects, the UE may initiate the uplink-only state based at least in part on expiration of a retransmission timer. In some aspects, a duration of the retransmission timer may be indicated in the configuration information described in connection with reference number 602. In some aspects, the duration of the retransmission timer may be indicated within a communication protocol.

As shown by reference number 618, the UE may perform one or more operations, described in connection with reference numbers 620-628, to support a retransmission of the first communication.

As shown by reference number 620, the UE may transmit an indication of initiation and/or a duration of the uplink-only state. For example, the UE may transmit the indication based at least in part on a number of uplink communications (e.g., data buffered for uplink transmission) that the UE intends to transmit before initiating the uplink and downlink state to receive a retransmission and/or a scheduling communication associated with the retransmission. In some aspects, the uplink communications may be time-sensitive (e.g., latency-sensitive) communications that are prioritized above the first communication. In some aspects, the UE may transmit an indication of a duration of the uplink-only state, with the duration being based at least in part on the data buffered for uplink transmission by the UE.

As shown by reference number 622, the UE may initiate the uplink-only state. In some aspects, the UE may initiate the uplink-only state at generally a same time as transmitting the indication of reference number 620.

In some aspects, the UE may initiate the uplink-only state based at least in part on transmitting the NACK associated with the first communication, as described in connection with reference number 608, and/or based at least in part on transmitting the indication described in connection with reference number 620. In some aspects, the UE may initiate the uplink-only state based at least in part on an autonomous decision at the UE (e.g., based at least in part on an expected return trip time associated with an earliest reception of a retransmission of the first communication, among other examples), data buffered for uplink transmission by the UE (e.g., time-sensitive data), and/or a configured timer, among other examples.

As shown by reference number 624, the UE may initiate the uplink and downlink state. For example, the UE may initiate the uplink and downlink state based at least in part on an expected retransmission of the first communication.

In some aspects, the UE may initiate the uplink and the downlink state based at least in part on transmitting the data buffered for uplink transmission by the UE, as described in connection with reference number 622. In some aspects, the UE may initiate the uplink and downlink state based at least in part on receiving (e.g., from the network node) an indication to initiate the uplink and downlink state. For example, the UE may receive the indication to initiate the uplink and downlink state via a WUR (e.g., as a WUS-based) indication. In some aspects, the UE may receive the indication to initiate the uplink and downlink state via a DCI message. In some aspects, the UE may initiate the uplink and downlink state based at least in part on a configured timer associated with reception of a retransmission of the communication.

As shown by reference number 626, the UE may receive, and the network node may transmit, an indication of an allocation associated with retransmission of the first communication, and/or the retransmission of the first communication. For example, the UE may receive a first message that indicates scheduling for the retransmission of the first communication (e.g., via DCI), and may receive the retransmission of the first communication based at least in part on the first message.

As shown by reference number 628, the UE may initiate the uplink-only state. In some aspects, the UE may initiate the uplink-only state based at least in part on expiration of a timer associated with the uplink and downlink state. Additionally, or alternatively, the UE may initiate the uplink-only state based at least in part on receiving the retransmission of the first communication.

As shown by reference number 630, the UE may receive an indication of second resources associated with a second communication. For example, the UE may receive the indication of the second resources after again initiating the uplink and downlink state (e.g., based at least in part on a configured schedule for initiating the uplink and downlink state).

As shown by reference number 632, the UE may receive, and the network node may transmit, the second communication via the second resources.

As shown by reference number 634, the UE may transmit, and the network node may receive, an ACK associated with the second communication. For example, the UE may transmit the ACK based at least in part on successful decoding of the second communication.

As shown by reference number 636, the UE may initiate the uplink-only state. For example, the UE may initiate the uplink-only state based at least in part on not expecting (e.g., based at least in part on transmitting the ACK) to receive a retransmission of the second communication and/or a scheduling message associated with the retransmission of the second communication.

As shown by reference number 638, the UE may transmit, and the network node may receive, a third communication. In some aspects, the third communication may be associated with a resource for the network node to transmit HARQ feedback.

As shown by reference number 640, the UE may remain in or initiate the uplink-only state after transmitting the third communication. While in the uplink-only state, the UE may monitor for a trigger to initiate the uplink and downlink state, as shown by reference number 642. In some aspects, the UE may receive the trigger as a WUS. The UE may receive the WUS via a WUR that operates with reduced power consumption relative to a main receiver of the UE.

In some aspects, the network node may transmit the trigger based at least in part on failure to receive the third communication. In some aspects, after transmitting the trigger, the UE may initiate the uplink and downlink state that supports reception of a scheduling message associated with retransmission of the third communication.

Based at least in part on configuring the UE to receive a retransmission, to receive a scheduling message for the retransmission, and/or to receive a NACK from the network node during a resource that may otherwise be associated with an uplink-only state, the described techniques can be used to increase a likelihood of receiving or transmitting a retransmission of a communication that failed. In this way, the UE and the network node may conserve power, computing, communication, and/or network resources that may have otherwise been used to detect and correct the failed communication and or to communicate using one or more communication parameters configured to reduce a likelihood of a failed communication (e.g., based at least in part on reducing spectral efficiency to reduce an error rate). Additionally, or alternatively, the UE and the network node may improve a user experience.

As indicated above, FIG. 6 is provided as an example. Other examples may differ from what is described with respect to FIG. 6.

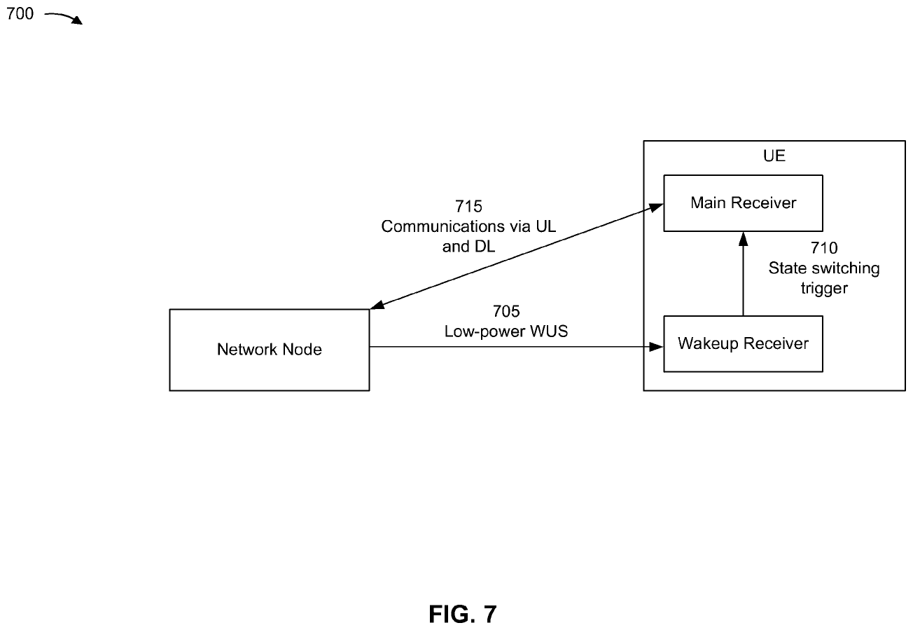

FIG. 7 is a diagram illustrating an example 700 of a WUR that supports reception of a WUS when a main receiver is in an uplink-only state, in accordance with the present disclosure.

As shown by reference number 705, a network node may transmit, and the UE may receive via a WUR, a low-power WUS. In some aspects, the low-power WUS may occupy a reduced bandwidth, may be encoded with a low-complexity encoding, and/or may otherwise cause the UE to receive the low-power WUS with reduced power consumption.

As shown by reference number 710, the UE may provide, from the WUR to the main receiver, a state switching trigger. The state switching trigger may indicate that the main receiver is to initiate an uplink and downlink state and/or exit an uplink-only state.

As shown by reference number 715, based at least in part on the main receiver initiating the uplink and downlink state, the UE and the network node may transmit and receive communications via uplink and downlink. In this way, the network node may transmit downlink communications that the UE could not have received while in the uplink-only state. For example, the UE would not support reception of a NACK, a scheduling message associated with a retransmission of a failed uplink communication, or retransmission of the failed uplink communication.

As indicated above, FIG. 7 is provided as an example. Other examples may differ from what is described with respect to FIG. 7.

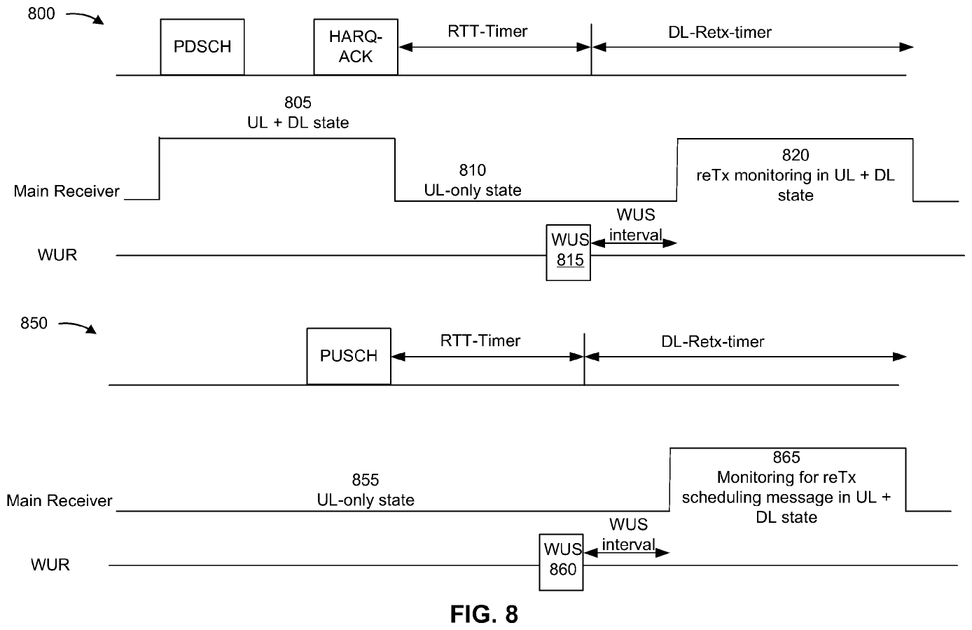

FIG. 8 is a diagram illustrating examples 800 and 850 of a WUS to indicate to a UE to initiate an uplink and downlink state, in accordance with the present disclosure. In the context of FIG. 8, the UE may switch between an uplink-only state and the uplink and downlink state for communications with a network node.

As shown in example 800, a main receiver of the UE may be in an uplink and downlink state 805 for reception of a PDSCH communication and transmission of an associated HARQ-ACK. The UE may initiate the uplink-only state 810 based at least in part on transmitting the HARQ-ACK.

Based at least in part on the HARQ-ACK indicating a NACK of the PDSCH communication, the network node may intend to transmit a scheduling message associated with a retransmission of the PDSCH communication. However, based at least in part on the UE being in the uplink-only state 810, the network node may first transmit a WUS 815 to indicate that the main receiver is to initiate the uplink and downlink state 805 to receive the scheduling message.

After receiving the WUS 815, the UE may begin to initiate the uplink and downlink state 805, which may become active after a WUS interval (e.g., a processing and/or switching time, and/or a configuration from the network node, among other examples).

While in the uplink and downlink state 805, the UE may perform retransmission (reTx) monitoring in the uplink and downlink state 820. In some aspects, the UE may receive the scheduling message and/or the retransmission of the PDSCH communication while in the uplink and downlink state 805 after the WUS interval.

As shown in example 850, a main receiver of the UE may be in an uplink-only state 855 for transmission of a PUSCH communication. In some aspects, the network node attempt to receive the PUSCH communication via resources allocated for the PUSCH. If the network node receives the PUSCH communication, the network node may allow the UE to remain in the uplink-only state 855. However, if the network node fails to receive the PUSCH communication, the network node may intend to transmit a NACK to trigger retransmission of the PUSCH.

Based at least in part on the UE being in the uplink-only state 855, the UE may be unable to receive the NACK and/or a request to retransmit the PUSCH communication. To trigger the UE to initiate the uplink and downlink state, the network node may transmit a WUS to the UE via a WUR of the UE. After the WUS interval, the UE may perform monitoring for a retransmission scheduling message in the uplink and downlink state 865. In some aspects, the network node may then transmit the scheduling message to the UE, and the UE may retransmit the PUSCH communication.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120) performs operations associated with communications using an uplink-only state.

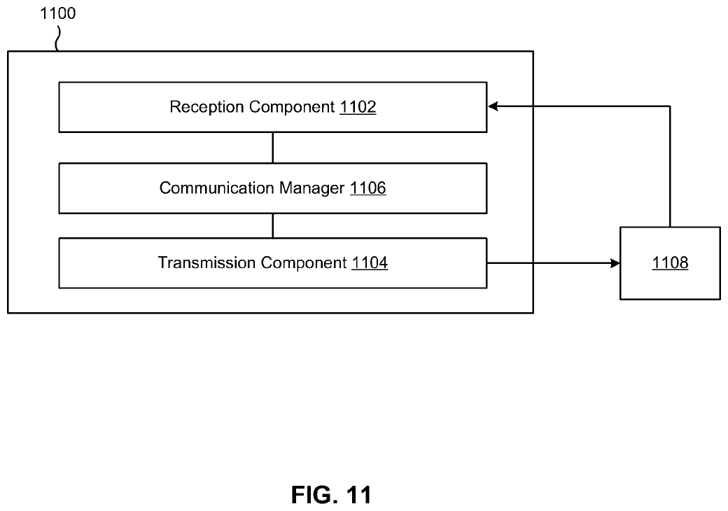

As shown in FIG. 9, in some aspects, process 900 may include receiving a first indication of an allocation of resources associated with a communication (block 910). For example, the UE (e.g., using reception component 1102 and/or communication manager 1106, depicted in FIG. 11) may receive a first indication of an allocation of resources associated with a communication, as described above.

As further shown in FIG. 9, in some aspects, process 900 may include transmitting a NACK associated with the communication (block 920). For example, the UE (e.g., using transmission component 1104 and/or communication manager 1106, depicted in FIG. 11) may transmit a NACK associated with the communication, as described above.

As further shown in FIG. 9, in some aspects, process 900 may include receiving, based at least in part on transmitting the NACK, a second indication to postpone initiation of an uplink-only state (block 930). For example, the UE (e.g., using reception component 1102 and/or communication manager 1106, depicted in FIG. 11) may receive, based at least in part on transmitting the NACK, a second indication to postpone initiation of an uplink-only state, as described above.

Process 900 may include additional aspects, such as any single aspect or any combination of aspects described below and/or in connection with one or more other processes described elsewhere herein.

In a first aspect, the second indication comprises one or more of a DCI message or a WUS.

In a second aspect, alone or in combination with the first aspect, process 900 includes remaining in an uplink and downlink state for a period of time, and initiating the uplink-only state based at least in part on expiration of a retransmission timer.

In a third aspect, alone or in combination with one or more of the first and second aspects, a message that includes the second indication further includes a third indication of a time window during which the UE is to postpone initiation of the uplink-only state.

In a fourth aspect, alone or in combination with one or more of the first through third aspects, process 900 includes initiating the uplink-only state based at least in part on one or more of receiving a retransmission of the communication, or expiration of a timer associated with reception of an allocation of resources associated with the retransmission of the communication.

In a fifth aspect, alone or in combination with one or more of the first through fourth aspects, receiving the second indication is based at least in part on an expected retransmission of the communication.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with the present disclosure. Example process 1000 is an example where the UE (e.g., UE 120) performs operations associated with communications using an uplink-only state.

As shown in FIG. 10, in some aspects, process 1000 may include receiving an indication of an allocation of resources associated with a communication (block 1010). For example, the UE (e.g., using reception component 1102 and/or communication manager 1106, depicted in FIG. 11) may receive an indication of an allocation of resources associated with a communication, as described above.

As further shown in FIG. 10, in some aspects, process 1000 may include transmitting a NACK associated with the communication (block 1020). For example, the UE (e.g., using transmission component 1104 and/or communication manager 1106, depicted in FIG. 11) may transmit a NACK associated with the communication, as described above.

As further shown in FIG. 10, in some aspects, process 1000 may include initiating an uplink-only state based at least in part on transmitting the NACK (block 1030). For example, the UE (e.g., using communication manager 1106, depicted in FIG. 11) may initiate an uplink-only state based at least in part on transmitting the NACK, as described above.

As further shown in FIG. 10, in some aspects, process 1000 may include initiating, after initiating the uplink-only state, an uplink and downlink state (block 1040). For example, the UE (e.g., using communication manager 1106, depicted in FIG. 11) may initiate, after initiating the uplink-only state, an uplink and downlink state, as described above.

Process 1000 may include additional aspects, such as any single aspect or any combination of aspects described below and/or in connection with one or more other processes described elsewhere herein.

In a first aspect, initiating the uplink-only state is based at least in part on one or more of an autonomous decision at the UE, data buffered for uplink transmission by the UE, or a configured timer.

In a second aspect, alone or in combination with the first aspect, initiating the uplink and downlink state is based at least in part on transmitting the data buffered for uplink transmission by the UE.

In a third aspect, alone or in combination with one or more of the first and second aspects, process 1000 includes transmitting an indication of one or more of a duration of the uplink-only state that is based at least in part on the data buffered for uplink transmission by the UE, or that the UE is initiating the uplink-only state.

In a fourth aspect, alone or in combination with one or more of the first through third aspects, initiating the uplink and downlink state is based at least in part on one or more of receiving an indication to initiate the uplink and downlink state, or a configured timer associated with reception of a retransmission of the communication.

In a fifth aspect, alone or in combination with one or more of the first through fourth aspects, receiving the indication to initiate the uplink and downlink state comprises receiving the indication via a wake up receiver.

In a sixth aspect, alone or in combination with one or more of the first through fifth aspects, the indication to initiate the uplink and downlink state comprises one or more of a DCI message or a WUS.

In a seventh aspect, alone or in combination with one or more of the first through sixth aspects, process 1000 includes initiating, after initiating the uplink and downlink state, the uplink-only state based at least in part on one or more of receiving a retransmission of the communication, or expiration of a timer associated with reception of an allocation of resources associated with the retransmission of the communication.

In an eighth aspect, alone or in combination with one or more of the first through seventh aspects, process 1000 includes receiving an indication of an allocation of additional resources associated with an additional communication, transmitting an ACK associated with the additional communication, and initiating the uplink-only state based at least in part on transmitting the ACK.

In a ninth aspect, alone or in combination with one or more of the first through eighth aspects, process 1000 includes receiving, after initiating the uplink and downlink state, an indication of an allocation of second resources associated with a retransmission of the communication.

In a tenth aspect, alone or in combination with one or more of the first through ninth aspects, process 1000 includes receiving an indication of one or more of a first duration of a timer associated with reception of an allocation of resources associated with a retransmission of the communication, a second duration of the uplink-only state, or a third duration of the uplink and downlink state.

In an eleventh aspect, alone or in combination with one or more of the first through tenth aspects, the indication of one or more of the first duration, the second duration, or the third duration is based at least in part on a traffic type of one or more of the communication or an uplink communication.

In a twelfth aspect, alone or in combination with one or more of the first through eleventh aspects, the indication of the one or more of the first duration, the second duration, or the third duration comprises an indication of a selection of the one or more of the first duration, the second duration or the third duration from a previously indicated set of candidate first durations, candidate second durations, or candidate third durations.

In a thirteenth aspect, alone or in combination with one or more of the first through twelfth aspects, process 1000 includes transmitting an additional communication, remaining in the uplink-only state after transmitting the additional communication, and monitoring for a trigger, from a network node, to initiate the uplink and downlink state based at least in part on a failure to receive the additional communication.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 6-8. Additionally, or alternatively, the apparatus 1100 may be configured to perform one or more processes described herein, such as process 900 of FIG. 9, process 1000 of FIG. 10, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive a first indication of an allocation of resources associated with a communication. The transmission component 1104 may transmit a NACK associated with the communication. The reception component 1102 may receive, based at least in part on transmitting the NACK, a second indication to postpone initiation of an uplink-only state.

The communication manager 1106 may remain in an uplink and downlink state for a period of time.

The communication manager 1106 may initiate the uplink-only state based at least in part on expiration of a retransmission timer.

The communication manager 1106 may initiate the uplink-only state based at least in part on one or more of receiving a retransmission of the communication, or expiration of a timer associated with reception of an allocation of resources associated with the retransmission of the communication.

The reception component 1102 may receive an indication of an allocation of resources associated with a communication. The transmission component 1104 may transmit a NACK associated with the communication. The communication manager 1106 may initiate an uplink-only state based at least in part on transmitting the NACK. The communication manager 1106 may initiate, after initiating the uplink-only state, an uplink and downlink state.

The transmission component 1104 may transmit an indication of one or more of a duration of the uplink-only state that is based at least in part on the data buffered for uplink transmission by the UE, or that the UE is initiating the uplink-only state.

The communication manager 1106 may initiate, after initiating the uplink and downlink state, the uplink-only state based at least in part on one or more of receiving a retransmission of the communication, or expiration of a timer associated with reception of an allocation of resources associated with the retransmission of the communication.

The reception component 1102 may receive an indication of an allocation of additional resources associated with an additional communication.

The transmission component 1104 may transmit an ACK associated with the additional communication.

The communication manager 1106 may initiate the uplink-only state based at least in part on transmitting the ACK.

The reception component 1102 may receive, after initiating the uplink and downlink state, an indication of an allocation of second resources associated with a retransmission of the communication.

The reception component 1102 may receive an indication of one or more of a first duration of a timer associated with reception of an allocation of resources associated with a retransmission of the communication, a second duration of the uplink-only state, or a third duration of the uplink and downlink state.

The transmission component 1104 may transmit an additional communication.

The communication manager 1106 may remain in the uplink-only state after transmitting the additional communication.

The communication manager 1106 may monitor for a trigger, from a network node, to initiate the uplink and downlink state based at least in part on a failure to receive the additional communication.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by a user equipment (UE), comprising: receiving a first indication of an allocation of resources associated with a communication; transmitting a negative acknowledgment (NACK) associated with the communication; and receiving, based at least in part on transmitting the NACK, a second indication to postpone initiation of an uplink-only state.
Aspect 2: The method of Aspect 1, wherein the second indication comprises one or more of a downlink control information (DCI) message or a wake-up signal (WUS).
Aspect 3: The method of any of Aspects 1-2, further comprising: remaining in an uplink and downlink state for a period of time, and initiating the uplink-only state based at least in part on expiration of a retransmission timer.
Aspect 4: The method of any of Aspects 1-3, wherein a message that includes the second indication further includes a third indication of a time window during which the UE is to postpone initiation of the uplink-only state.
Aspect 5: The method of any of Aspects 1-4, further comprising initiating the uplink-only state based at least in part on one or more of: receiving a retransmission of the communication, or expiration of a timer associated with reception of an allocation of resources associated with the retransmission of the communication.
Aspect 6: The method of any of Aspects 1-5, where receiving the second indication is based at least in part on an expected retransmission of the communication.
Aspect 7: A method of wireless communication performed by a user equipment (UE), comprising: receiving an indication of an allocation of resources associated with a communication; transmitting a negative acknowledgment (NACK) associated with the communication; initiating an uplink-only state based at least in part on transmitting the NACK; and initiating, after initiating the uplink-only state, an uplink and downlink state.
Aspect 8: The method of Aspect 7, wherein initiating the uplink-only state is based at least in part on one or more of: an autonomous decision at the UE, data buffered for uplink transmission by the UE, or a configured timer.
Aspect 9: The method of Aspect 8, wherein initiating the uplink and downlink state is based at least in part on transmitting the data buffered for uplink transmission by the UE.
Aspect 10: The method of Aspect 9, further comprising transmitting an indication of one or more of: a duration of the uplink-only state that is based at least in part on the data buffered for uplink transmission by the UE, or that the UE is initiating the uplink-only state.
Aspect 11: The method of any of Aspects 7-10, wherein initiating the uplink and downlink state is based at least in part on one or more of: receiving an indication to initiate the uplink and downlink state, or a configured timer associated with reception of a retransmission of the communication.
Aspect 12: The method of Aspect 11, wherein receiving the indication to initiate the uplink and downlink state comprises: receiving the indication via a wake up receiver.
Aspect 13: The method of Aspect 11, wherein the indication to initiate the uplink and downlink state comprises one or more of a downlink control information (DCI) message or a wake-up signal (WUS).
Aspect 14: The method of any of Aspects 7-13, further comprising initiating, after initiating the uplink and downlink state, the uplink-only state based at least in part on one or more of: receiving a retransmission of the communication, or expiration of a timer associated with reception of an allocation of resources associated with the retransmission of the communication.
Aspect 15: The method of any of Aspects 7-14, further comprising: receiving an indication of an allocation of additional resources associated with an additional communication; transmitting an acknowledgment (ACK) associated with the additional communication; and initiating the uplink-only state based at least in part on transmitting the ACK.
Aspect 16: The method of any of Aspects 7-15, further comprising: receiving, after initiating the uplink and downlink state, an indication of an allocation of second resources associated with a retransmission of the communication.
Aspect 17: The method of any of Aspects 7-16, further comprising receiving an indication of one or more of: a first duration of a timer associated with reception of an allocation of resources associated with a retransmission of the communication, a second duration of the uplink-only state, or a third duration of the uplink and downlink state.
Aspect 18: The method of Aspect 17, wherein the indication of one or more of the first duration, the second duration, or the third duration is based at least in part on a traffic type of one or more of the communication or an uplink communication.
Aspect 19: The method of Aspect 17, wherein the indication of the one or more of the first duration, the second duration, or the third duration comprises: an indication of a selection of the one or more of the first duration, the second duration or the third duration from a previously indicated set of candidate first durations, candidate second durations, or candidate third durations.
Aspect 20: The method of any of Aspects 7-19, further comprising: transmitting an additional communication; remaining in the uplink-only state after transmitting the additional communication; and monitoring for a trigger, from a network node, to initiate the uplink and downlink state based at least in part on a failure to receive the additional communication.
Aspect 21: An apparatus for wireless communication at a device, comprising a processor; memory coupled with the processor; and instructions stored in the memory and executable by the processor to cause the apparatus to perform the method of one or more of Aspects 1-20.
Aspect 22: A device for wireless communication, comprising a memory and one or more processors coupled to the memory, the one or more processors configured to perform the method of one or more of Aspects 1-20.
Aspect 23: An apparatus for wireless communication, comprising at least one means for performing the method of one or more of Aspects 1-20.
Aspect 24: A non-transitory computer-readable medium storing code for wireless communication, the code comprising instructions executable by a processor to perform the method of one or more of Aspects 1-20.
Aspect 25: A non-transitory computer-readable medium storing a set of instructions for wireless communication, the set of instructions comprising one or more instructions that, when executed by one or more processors of a device, cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

1. A user equipment (UE) for wireless communication, comprising:
one or more memories; and
one or more processors coupled to the one or more memories, the one or more processors individually or collectively configured to:
receive a first indication of an allocation of resources associated with a communication;
transmit a negative acknowledgment (NACK) associated with the communication; and
receive, based at least in part on the NACK, a second indication to postpone initiation of an uplink-only state.

2. The UE of claim 1, wherein the second indication comprises one or more of a downlink control information (DCI) message or a wake-up signal (WUS).

3. The UE of claim 1, wherein the one or more processors individually or collectively are further configured to:
remain in an uplink and downlink state for a period of time, and
initiate the uplink-only state based at least in part on expiration of a retransmission timer.

4. The UE of claim 1, wherein a message that includes the second indication further includes a third indication of a time window during which the UE is to postpone initiation of the uplink-only state.

5. The UE of claim 1, wherein the one or more processors individually or collectively are further configured to initiate the uplink-only state based at least in part on one or more of:
receive a retransmission of the communication, or
expiration of a timer associated with reception of an allocation of resources associated with the retransmission of the communication.

6. The UE of claim 1, wherein reception of the second indication is based at least in part on an expected retransmission of the communication.

7. A UE for wireless communication, comprising:
one or more memories; and
one or more processors coupled to the one or more memories, the one or more processors individually or collectively configured to:
receive an indication of an allocation of resources associated with a communication;
transmit a negative acknowledgment (NACK) associated with the communication;
initiate an uplink-only state based at least in part on the NACK; and
initiate, after the uplink-only state is initiated, an uplink and downlink state.

8. The UE of claim 7, wherein initiation of the uplink-only state is based at least in part on one or more of:
an autonomous decision at the UE,
data buffered for uplink transmission by the UE, or
a configured timer.

9. The UE of claim 8, wherein initiation of the uplink and downlink state is based at least in part on transmitting the data buffered for uplink transmission by the UE.

10. (canceled)

11. The UE of claim 7, wherein initiation of the uplink and downlink state is based at least in part on one or more of:
reception of an indication to initiate the uplink and downlink state, or
a configured timer associated with reception of a retransmission of the communication.

12. (canceled)

13. (canceled)

14. The UE of claim 7, wherein the one or more processors individually or collectively are further configured to initiate, after initiating the uplink and downlink state, the uplink-only state based at least in part on one or more of:
receive a retransmission of the communication, or
expiration of a timer associated with reception of an allocation of resources associated with the retransmission of the communication.

15. The UE of claim 7, wherein the one or more processors individually or collectively are further configured to:
receive an indication of an allocation of additional resources associated with an additional communication;
transmit an acknowledgment (ACK) associated with the additional communication; and
initiate the uplink-only state based at least in part on transmitting the ACK.

16. The UE of claim 7, wherein the one or more processors individually or collectively, to initiate the uplink-only state, are configured to:
initiate the uplink-only state after expiration of a retransmission timer, or
initiate the uplink-only state after receiving a retransmission of the communication.

17. The UE of claim 7, wherein the one or more processors individually or collectively are further configured to:
receive, after initiating the uplink-only state, an indication of an allocation of second resources associated with a retransmission of the communication.

18. The UE of claim 7, wherein the one or more processors individually or collectively are further configured to receive an indication of one or more of:
a first duration of a timer associated with reception of an allocation of resources associated with a retransmission of the communication,
a second duration of the uplink-only state, or
a third duration of the uplink and downlink state.

19. (canceled)

20. (canceled)

21. The UE of claim 7, wherein the one or more processors individually or collectively are further configured to:
transmit an additional communication;
remain in the uplink-only state after transmitting the additional communication; and
monitor for a trigger, from a network node, to initiate the uplink and downlink state based at least in part on a failure to receive the additional communication.

22. A method of wireless communication performed by a user equipment (UE), comprising:
receiving a first indication of an allocation of resources associated with a communication;
transmitting a negative acknowledgment (NACK) associated with the communication; and
receiving, based at least in part on transmitting the NACK, a second indication to postpone initiation of an uplink-only state.

23. The method of claim 22, wherein the second indication comprises one or more of a downlink control information (DCI) message or a wake-up signal (WUS).

24. The method of claim 22, further comprising initiating the uplink-only state based at least in part on one or more of:
receiving a retransmission of the communication, or
expiration of a timer associated with reception of an allocation of resources associated with the retransmission of the communication.

25. The method of claim 22, where receiving the second indication is based at least in part on an expected retransmission of the communication.

26-30. (canceled)
